(19) United States
(12) Patent Application Publication
(10) Pub. No.: US 2014/0230019 A1
(43) Pub. Date: Aug. 14, 2014

(54) AUTHENTICATION TO A FIRST DEVICE USING A SECOND DEVICE

(71) Applicant: Google Inc., Mountain View, CA (US)

(72) Inventors: Jay Pierre Civelli, Sunnyvale, CA (US); Roma Shah, San Francisco, CA (US)

(73) Assignee: Google Inc., Mountain View, CA (US)

(21) Appl. No.: 13/766,821

(22) Filed: Feb. 14, 2013

(51) Int. Cl. G06F 21/30

(52) U.S. Cl. CPC G06F 21/30
USPC 726/4

(57) ABSTRACT

A token that authenticates a user to a device such as a mobile phone is disclosed. Each device may be associated with multiple tokens such that each token has an authorization configuration. The device may receive an authentication signal from one of the tokens. The authorization configuration that corresponds to the token that provides an authentication signal may be identified. The device may receive an access request. The requested access may be provided based on the authorization configuration and the access request.

### BACKGROUND

Secure electronic access is used in a variety of applications such as: door security systems, mass transport access and payment, computers, bank vaults, safes, and mobile devices. Many mobile devices possess the ability to require a user to pass a security check before being allowed to access the device (e.g., enter a Personal Identification Number (“PIN”), swipe a pattern, facial recognition). Performing this process is obtrusive and laborious for mobile devices and for applications of similar security measures.

### BRIEF SUMMARY

According to an implementation of the disclosed subject matter, a device may receive an authentication signal from a first of several tokens. Each token may be associated with an authorization configuration. The first token may be authenticated based on the authentication signal. The authorization configuration may be a permission setting that corresponds to, for example, a service at the device, an application at the device, content stored on the device, a service provided remotely from the device, an application provided remotely from the device, and content stored at a location remote from the device. The first token may be identified. The device may receive an access request. The requested access may be provided based on the authorization configuration and the access request. In some configurations, a query may be sent from the device to the first token and the query may transfer sufficient power to the first token to generate the authentication signal. In some configurations, it may be determined that a predetermined time has elapsed since the device received an authentication signal from the token and the device may be changed to a secure state.

In some configurations, each token may include a token locked state and a token unlocked state. It may be determined that a predetermined time has elapsed since the first of the plurality of tokens received a query from the device exceeds a token timeout threshold and the unlocked state may be changed to a token locked state.

In an implementation, a system is provided that includes one or more tokens and a device. Each token may be associated with an authorization configuration. The device may include a processor configured to receive at the device an authentication signal from a first token. It may authenticate the first token based on the authentication signal. The processor may identify the authorization configuration that corresponds to the first token. It may receive at the device an access request and provide the requested access based on the authorization configuration and the access request.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process according to an implementation disclosed herein.

### DETAILED DESCRIPTION

In an implementation, a token may authenticate a user to the user's device (e.g., mobile device). A token may be a small, passive device that a user can wear such as a ring. The token or ring may use near field communication technology and provide high-security cryptography (e.g., through a chip contained in it), ensuring that only the owner of the ring can unlock the user's device. The user may wear the ring on the less dexterous hand (e.g., left hand for right-handed people, right hand for left-handed people). When the user holds the mobile device with the hand on which the ring is fitted, the back of the mobile device may be in proximity to the ring. An easy gesture (e.g., double-tap, quick-swipe), touching the screen, or pressing a hard or virtual button may notify the mobile device that the user is requesting to unlock it. The mobile device may activate the NFC capability and authenticate with the ring. Successful authentication may cause the mobile device to be unlocked.

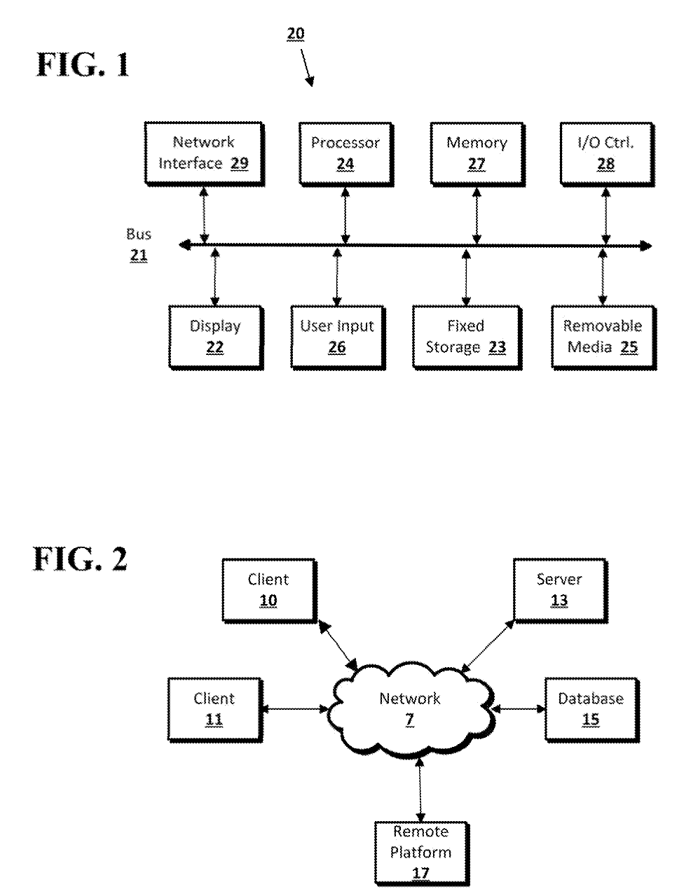

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In an implementation, an authentication signal may be received at a device from a first of one or more tokens at 310. A token may include a wearable item such as a ring, a bracelet, an earring, a pin, or a tag. A device may refer to, for example, a vehicle, a computing device, a door, a mobile device, a tablet such as a tablet or smartphone, or the like. An authentication signal may be provided in a variety of ways such as an audio signal, a light signal, a radio signal, or the like. The signal may communicate, for example: an alphanumeric and/or character sequence, an image, a text, or the like. The signal may be unique to each individual token and used as an authentication factor (e.g., as a component of two- or three-factor authentication). The signal may be transmitted to the device using a variety of communication techniques known to those skilled in the art, such as Bluetooth, NFC, etc. The authentication signal of the first token may differ from a subsequent authentication signal (e.g., from a different token).

In some configurations, a query may be sent from the device to the first token. The query from the device may transfer sufficient power to the first token to generate the authentication signal. For example, NFC can transfer power between a powered NFC chip (e.g., the chip may be a component of the device) and an unpowered NFC chip (e.g., the chip may be a component of the token). A query from the device to the token may be triggered in a number of ways, such as: detecting movement the device using an accelerometer, detecting movement of the device using a gyroscope, receiving an incoming call, receiving an incoming email, receiving an incoming text, detecting a change in light level, recognizing a face, recognizing a scene, detecting a computer readable graphic, detecting a QR code, detecting a gesture, detecting an audible sound, recognizing a voice, detecting a sound of a predetermined intensity, detecting a sound of a predetermined pitch, detecting a sound of a predetermined range, and detecting a keyboard input, detecting a PIN, a key, a passphrase, and detecting a motion from a camera.

The first token may be authenticated based on the authentication signal at 320. Different tokens each may communicate an authentication signal to the device, for example, when in sufficient proximity to the device. A proximity may include, for example, a distance of four centimeters between the token and the device in configurations where the device and token communicate using NFC. In some configurations, the device may detect a gesture, such as a tap or a swipe motion, when the token is in proximity to the device. For example, a token may be a ring and the device may be a smartphone. The token may be authenticated to the device by, for example, tapping the back side of a smartphone. The back side of a smartphone may be the side of the phone that does not have an exposed display. In some configurations the device may only recognize a single authentication signal from a single token. In some configurations, the authentication signal, upon being received by the device, may cause the device to permit the user to access one or more applications, services, and/or configurations.

In some instances, the token may be paired with the device initially. For example, the device may be a smartphone and the token may be a ring. The user may purchase the ring from a store. The ring may be paired with the smartphone to allow the user to access the device without having to, for example, enter a PIN or answer a challenge. During the pairing process, the user may be asked to take a picture of the ring or otherwise enter identifying information about the token in case the user has multiple tokens or rings. Tokens may then be added/removed by the user, administrator, or a service as the needed (e.g., in case the user lost one of the rings). The presence of a token may not necessarily preclude accessing the device using other means. For example, a user may still use a conventional cryptographic technique such as a PIN or username and/or password to access the device despite having the token in proximity to the device. Such a configuration may be desirable in case a user loses the token. In such an event, the user may still be able to access the device.

A token may have a token locked state and a token unlocked state. As stated earlier, the token may be a component of two factor authentication, for example. In the event it is lost or stolen, and if lost/stolen with the device, it could provide full access to the device. To protect against this possibility, the ring may be placed in a locked state. For example, if the token is a ring, it may be placed in a locked state when it is not worn by the bearer. When it is put on and used to unlock a mobile device it may, for example, require a user to enter a PIN or other response to a cryptographic challenge to change the token to an unlocked state. In the unlocked state, the mere proximity of the token with the device may be sufficient to authenticate a user to the device and provide the user with access to the device according to the authorization configuration associated with the token.

To transition the token from a locked state to an unlocked state, the user may need to answer a cryptographic challenge presented on the device to which the user is attempting to authenticate the token. The cryptographic challenge may only be requested the first time the token is utilized to unlock the mobile device. For example, the token may be configured to present a cryptographic challenge to the user upon the first attempted access of the device via the token each day. The locking mechanism may be implemented by light sensors on the inside of the token, for example where the token is a worn item such as a ring. Once the token or ring is removed and light reaches the sensors, a current may be created that switches the ring to the locked state at which point it refuses any further authentication requests or ceases transmitting the authentication signal. In some configurations, it may be determined that a predetermined time that has elapsed since the first token received a query from the device exceeds a token timeout threshold. The token may be changed from an unlocked state to a token locked state. Other sensors may be incorporated with the token such as biometric sensors (e.g., a heat sensor, a fingerprint reader).

In an implementation, it may be determined that a predetermined time has elapsed since the device received an authentication signal from the token. The device may be changed to a secure state. In some configurations, the device may query the first token at a predetermined interval. The query may be an authentication request that asks the token to transmit the authentication signal. In some configurations, the authentication signal may be transmitted to the device, when it has power, at an interval or only in response to an authentication request. In the event that the token fails to respond to the authentication request, for example where the token is not within a specified proximity to the device to receive a power transfer or where the token is in a locked state, the device may be placed in a secure state. A secure state may refer to an instance in which the device requires the user to answer a cryptographic challenge (e.g., enter a PIN, a password, or the like).

If the device and token utilize asymmetric keys, the public key may be synced with the user's other devices so that they also may be unlocked with the same token without any further configuration. A microchip component of the token may contain a private key. When the device detects the token, it may send a challenge to it. The token may sign the challenge with the private key and transmit it back to the device. The device may verify the signature and unlock itself if the signature is correct and, for example, the public key has been registered with the phone. Symmetric keys also may be exchanged when the token and the device are paired. This may prevent decryption of any further communication between the token and the device. A skilled artisan will know that many asymmetric and symmetric encryption algorithms or schemes may be employed in accordance with the disclosed subject matter. Other cryptographic methods also may be applicable to or compatible with the disclosed subject matter.

As another example of a cryptographic communication involving the token and the device. The device may store a secret on the token and verify that secret when the device and ring connect. This method may rely on the connection between the device and the token being secure. The token may also store application specific information. For example, each application on the device may have a unique symmetric key. This may allow a user to configure a device to set application-specific permission settings. Other features besides or in addition to applications may also be associated with a unique symmetric key. For example, where the device is not a smartphone, tablet, computer, or the like, it may not have any applications. The device may have software, executable code, an operating system, or the like may provide an API that the applications and/or features use. The application/feature may have a secure storage n the user's token that only it can access. The device's software, executable code, operating system, or the like may query application's/feature's. The secret may be validated by the device or by a remote server. Successfully obtaining the secret by the device may guarantee that the expected user is utilizing the device and that the application/feature can be activated or initiated without a password, PIN, or other log-in mechanism. Failure to obtain to the secret may cause the device to default back to a conventional log in mechanism (e.g., a PIN, password, etc.). The default back to a conventional log in mechanism may be desirable for instances where, for example, the user loses the token.

Each token may be associated with an authorization configuration. An authorization configuration may include a permission setting such as a type of access, an authentication requirement, or an authorization requirement. A type of access may refer to, for example, a read, a write, an execute function, or a delete function. An authentication requirement may refer, for example, to requiring a PIN or the like that may provide an additional level of security beyond that of the token and the device. An authorization requirement may refer to a need to obtain a permission or access to certain data or functionality. A permission setting may at least partly relate pertain to a service at the device, an application at the device, content stored on the device, a service provided remotely from the device, an application provided remotely from the device, and content stored at a location remote from the device. For example, an authorization configuration may permit the bearer of a first token to access programs A, B, and C while the bearer of a second token may be permitted to access applications C, D, and E. Two or more tokens may share an authorization configuration or have an identical authorization configuration. The authorization configuration may be stored on the device or at a remote location. For example, the authorization configuration may be linked to a user account. When the token sends the authentication signal and is authenticated to the device, the device may query a server to obtain the authorization configuration for the particular token. The authorization signal may be used as the basis for querying the server to obtain the authorization configuration. The device also may query a server to authenticate the token.

The authorization configuration may cause the user interface to change. Returning to the previous example, the authorization configuration associated with a first token may cause the device to display a subset of applications for which the user has permission to access (e.g., A, B, and C). Permission to other settings, services, or configurations that are remote or local to the device may be apportioned using the authorization configuration associated with the token. Also, the disclosure is not limited to the device being a mobile device such as a smartphone. For example, a front door to a house may have different settings for different users based on the authorization configuration. One token may specify a certain lights to turn on based upon an authorization configuration for a user attempting to gain access to the house. A second token may be associated with an authorization configuration that specifies a different set of lights to be activated.

An authorization configuration may be generated, for example, by an administrator of the device. The administrator may be an individual who owns the device or has access to the full complement of applications, services, or configurations for the device. There may be more than one individual or entity that has the ability to generate an authorization configuration or act as an administrator. An authorization configuration may also be automatically generated. For example, an administrator may deem an employee level required to access a safe. Two authentication configurations may be generated—one for those users with the appropriate employee level to access the device (i.e., the safe) and one for those who do not possess the appropriate employee level to access the safe. The token may communicate the employee level along with the authentication signal or employee level may be a component of the authentication signal itself. Thus, a token may be associated with a particular group that has a specified permission setting based on the group identity.

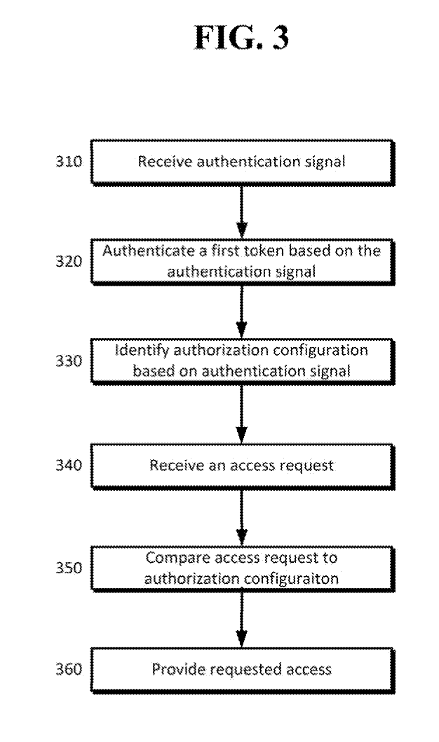

A device may have one or more authorization configurations stored on it or it may have the ability to access one or more remotely stored authorization configurations. Returning to FIG. 3, the authorization configuration that corresponds to the first token may be identified based on the authentication signal at 330. An authorization configuration may be generated as part of the initial pairing of the token to the device. In some configurations, more than one token may pair to one or more devices. For example, a computer may contain several authorization configurations. One authorization configuration may correspond to the administrator or the primary user of the computer. Other authorization configurations may correspond to users of the same computer. The access privileges of the other users may be restricted based on the authorization configuration. The authorization configuration corresponding to a given user or bearer of the token may be taken from the authentication signal sent by the token. The device may compare the information received from the token to, for example, a local database containing the user and the permission settings or authorization configuration. Likewise, the device may query a remote database to identify the authorization configuration for the user or token bearer.

The device may receive an access request at 340. An access request may be, for example, an application request, a function request, a wireless communication request, or the like. Examples of an application request may be, for example, where the user of a computer (e.g., a device) attempts to launch a word processing or email application. Examples of a function request may include sending or receiving a text message, a phone call, a picture, or any other electronic transmission, or capturing a picture or video or accessing a camera. A wireless communication request may include activating a wireless radio. An application request, a function request, and a wireless communication request or any combination thereof may be employed in a single access request. For example, a user may desire to send a text message from the user's device, a mobile phone. The user may launch a text messaging application and send the text message using a cellular radio.

An access request may be compared to the authorization configuration associated with the token 350 to determine if the requested access is permissible. If the requested access is determined to be permissible, then the requested access may be provided 360.

In an implementation, a system is provided that includes a first of a plurality of tokens and a device. Each token may be associated with an authorization configuration. The device may include a processor configured to receive an authentication signal from the first token and authenticate the first token based on the authentication signal. The processor may identify the authorization configuration that corresponds to the first token and receive at the device an access request. It may provide the requested access based on the authorization configuration and the access request.

A token may be used in a variety of other areas besides mobile devices. For example, to access a computer, a desktop or laptop could use the ring to login. Similarly, a hotel may ask a user may swipe the ring. The hotel could then give the user access to the appropriate room for the ring specifically for the duration of the user's stay. As another example, a car may utilize the ring to unlock it or specific compartments or electronics within the vehicle. A token may be associated with a user profile. The user profile may include or be an authorization configuration. Information in a user profile may include, for example and without limitation, a username, a birthdate, an image such as a profile image, a mobile phone number, an email address, a social network user identifier, a gender, a video content, an audio content, a location, and a country. In addition, the user profile may indicate whether or not the user is interested in receiving on-screen alerts or connecting to the social networking system of other users, or an activity history. For example, a user profile may include information that is aggregated based upon the first user's online activity or access history. The user profile may be used by the user to designate groups, such as a friend group, whom the user would like to have a specified access level to a device the user owns.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method, comprising:
receiving at a device an authentication signal from a first of a plurality of tokens, each token associated with an authorization configuration;
authenticating the first of the plurality of tokens based on the authentication signal;
identifying the authorization configuration that corresponds to the first of the plurality of tokens;
receiving at the device an access request; and
providing the requested access based on the authorization configuration and the access request.

2. The method of claim 1, further comprising sending a query from the device to the first of the plurality of tokens.

3. The method of claim 2, wherein the query from the device transfers sufficient power to the first of the plurality of tokens to generate the authentication signal.

4. The method of claim 2, wherein the query is triggered based on at least one selected from the group consisting of: detecting movement the device using an accelerometer, detecting movement of the device using a gyroscope, receiving an incoming call, receiving an incoming email, receiving an incoming text, detecting a change in light level, recognizing a face, recognizing a scene, detecting a computer readable graphic, detecting a QR code, detecting a gesture, detecting an audible sound, recognizing a voice, detecting a sound of a predetermined intensity, detecting a sound of a predetermined pitch, detecting a sound of a predetermined range, and detecting a keyboard input, detecting a Personal Identification Number, a key, a passphrase, and detecting a motion from a camera.

5. The method of claim 1, wherein the authentication signal of the first of the plurality of tokens differs from a subsequent authentication signal.

6. The method of claim 1, wherein an authorization configuration comprises a permission setting that corresponds to at least one from the group consisting of: a service at the device, an application at the device, and content stored on the device.

7. The method of claim 1, wherein an authorization configuration comprises a permission setting that corresponds to at least one from the group consisting of: a service provided remotely from the device, an application provided remotely from the device, and content stored at a location remote from the device.

8. The method of claim 6, wherein a permission setting is selected from at least one of the group consisting of: a type of access, an authentication requirement, or an authorization requirement.

9. The method of claim 7, wherein a permission setting is selected from at least one of the group consisting of: a type of access, an authentication requirement, or an authorization requirement.

10. The method of claim 1, wherein an access request is selected from the group consisting of: an application request, a function request, and a wireless communication request.

11. The method of claim 1, further comprising:
determining that a predetermined time has elapsed since the device received an authentication signal from the token; and
changing the device to a secure state.

12. The method of claim 1, wherein the first of the plurality of tokens comprises a token locked state and a token unlocked state.

13. The method of claim 12, further comprising determining that a predetermined time has elapsed since the first of the plurality of tokens received a query from the device exceeds a token timeout threshold and changing the unlocked state to a token locked state.

14. The method of claim 1, wherein the device provides a query to the first of the plurality tokens at a predetermined interval.

15. The method of claim 1, further comprising detecting a gesture when the first of the plurality of tokens is in proximity to the device.

16. The method of claim 15, wherein proximity comprises a distance of four centimeters.

17. The method of claim 1, wherein the device is selected from the group consisting of: a door, a mobile device, a vehicle, and a computing device.

18. The method of claim 1, wherein the first of the plurality of tokens comprises a wearable item selected from the group consisting of: a ring, a bracelet, an earring, a pin, or a tag.

19. The method of claim 12, further comprising determining that the token biometric marker is not detected and changing the first of the plurality of tokens from the token unlocked state to the token locked state.

20. The method of claim 12, further comprising detecting light by the first of the plurality of tokens and changing the first of the plurality of tokens from the token unlocked stated to the token locked state.

21. A system comprising:
a first of a plurality of tokens, each token associated with an authorization configuration;
a device, the device comprising a processor configured to:
receive at the device an authentication signal from the first of the plurality of tokens;
authenticate the first of the plurality of tokens based on the authentication signal;
identify the authorization configuration that corresponds to the first of the plurality of tokens;
receive at the device an access request; and
provide the requested access based on the authorization configuration and the access request.

22. The system of claim 21, further comprising sending a query from the device to the first of the plurality of tokens.

23. The system of claim 22, wherein the query from the device transfers sufficient power to the first of the plurality of tokens to generate the authentication signal.

24. The system of claim 22, wherein the query is triggered based on at least one selected from the group consisting of: detecting movement the device using an accelerometer, detecting movement of the device using a gyroscope, receiving an incoming call, receiving an incoming email, receiving an incoming text, detecting a change in light level, recognizing a face, recognizing a scene, detecting a computer readable graphic, detecting a QR code, detecting a gesture, detecting an audible sound, recognizing a voice, detecting a sound of a predetermined intensity, detecting a sound of a predetermined pitch, detecting a sound of a predetermined range, and detecting a keyboard input, detecting a Personal Identification Number, a key, a passphrase, and detecting a motion from a camera.

25. The system of claim 21, wherein the authentication signal of the first of the plurality of tokens differs from a subsequent authentication signal.

26. The system of claim 21, the processor further configured to:
determine that a predetermined time has elapsed since the device received an authentication signal from the token; and
change the device to a secure state.

27. The system of claim 21, wherein the first of the plurality of tokens comprises a token locked state and a token unlocked state.

28. The system of claim 27, the processor further configured to:
determine that a predetermined time has elapsed since the first of the plurality of tokens received a query from the device exceeds a token timeout threshold; and
change the unlocked state to a token locked state.

29. The system of claim 27, the processor further configured to:
determine that the token biometric marker is not detected; and
change the first of the plurality of tokens from the token unlocked state to the token locked state.

30. The method of claim 27, the processor further configured to:
detect light by the first of the plurality of tokens; and
change the first of the plurality of tokens from the token unlocked stated to the token locked state.
